(19) United States
(12) Patent Application Publication
(10) Pub. No.: US 2004/0114231 A1
(43) Pub. Date: Jun. 17, 2004

(54) Improved 3D Imaging System using Reflectors

(76) Inventor: Anthony Lo, Hong Kong (CN)

Correspondence Address: Anthony, Lo, Rm. 7, 7/fl., New City Centre, 2, Lei Yue Mun Road, Kwun Tong, Kowloon, Hong Kong

(21) Appl. No.: 10/605,393

(22) Filed: Sep. 27, 2003

(30) Foreign Application Priority Data
Sep. 25, 2002 (GB) 0222244.6

(51) Int. Cl. G02B 27/22

(52) U.S. Cl. 359/462; 359/464

(57) ABSTRACT

An improved 3D Imaging System Using Reflectors is provided. The device includes a beam splitter system comprising an even number of mirrors. The device also includes a lens panel that has two independent image forming lenses, and an aperture panel with a pair of apertures. The aperture panel is positioned between the beam splitter and lens plane to project dual images of the subject onto a film exposure or ground glass. The alignment of lens, aperture and beam splitter mirrors creates a pair of divergent light paths from lens pair to exposure plane, which simulates a single lens, permitting accurate light metering and a bright viewfinder image when the device is used with a Single Lens Reflex (SLR) camera.

### CROSS REFERENCE TO RELATED APPLICATIONS

This application claims priority rights under 35 U.S.C. .sctn. 119(e)(1) based on provisional U.K. Patent Application GB 0222244.6 filed on Sep. 25, 2002.

### BACKGROUND OF INVENTION

The present invention relates to an integrated lens, aperture and beam splitter system for taking stereo photographs. The system is for use as a lens attachment for Single Lens Reflex cameras.

The popularity of three-dimensional, or stereo, photographs is increasing along with technological advances in the field. Stereo photographs are created by projecting dual images of the same subject adjacent to each other on the same exposure of film. The camera lenses that project each of the images of the subject are slightly offset from each other so that the film exposure captures to two different angles of the same subject. The resulting effect of the developed film, when viewed through an appropriate viewer, is a three-dimensional, or stereo, photograph.

There are multi-role cameras, which can perform different photographic tasks as though they are purpose built for the job. Some examples are telescopic photography, wide-angle photography and microscopic photography. However there are no stereoscopic attachments in the market for these cameras which can produce stereo images to rival those produced by purpose built stereo cameras.

The basic difference between a monoscopic camera and a simple stereoscopic camera is that the former captures one image and the latter captures a pair of images simultaneously from two viewpoints separated laterally by approximately 65 mm.

Any attempt to capture the pair of stereo images on a single frame will usually involve the use of reflectors or beam splitters. These are known to carry the penalty of a narrow field of view and require skilful masking between the two images, particularly if one lens is used to capture the pair of images. If one lens is used to capture two images, various degrees of keystone distortion will make the viewing of the images in stereo uncomfortable. The wider the angle of view the worse the keystone effect.

An example of a purpose built stereo camera is the Stereo Realist. The Stereo Realist is in essence two separate cameras mounted in a common frame. It produces a pair of stereo images with a pair of lenses set 65 mm apart. It has synchronized shutters and exposure control.

To enable monoscopic cameras to take stereo pictures, beam splitters have been devised to produce a pair of side-by-side transposed images on a single frame. It is desirable to have images in this format because they can be easily viewed without remounting. Examples of such beam splitters are the Kodak Retina series, Pentax and the Zeiss Contaflex.

However, images produced by these beamsplitters are not of comparable quality to those produced by a purpose-built stereo camera such as the Stereo Realist. There is severe keystone effect and restricted angle of view. The angle of view can be widened by using a wider supporting lens. The penalty for doing this is severe keystone distortion and vignetting. The wider the angle of view the worse the keystone distortion. Keystone distortion makes 3D images uncomfortable to view, and when severe, can destroy the 3D effect altogether because key parts of the two images do not merge.

In a stereo pair it is desirable to have a clearly defined partition. It is difficult to achieve this with a single lens beam splitter. It is even more difficult to maintain the partition when there is adjustable aperture.

There are two identifiable, previously proposed beam splitter systems in the art, which address these issues while producing correctly transposed images. The following table compares their strengths and weaknesses with the 3D Imaging System proposed in this application.

[Strengths and Weaknesses of Previously Proposed Beamsplitter Systems]

The popularity of stereo photographs depends on the ease of creation as well as viewing of the content. The ultimate in ease of use is defined as images that can be captured as seen through a viewfinder, and immediately viewable in stereo effect through a stereo viewer without re-mounting. To achieve this ease of use the stereo images need to be captured correctly transposed, on a single frame of film or digital exposure.

Technological advances in imaging capturing cameras have given rise to accurate viewing, exposure control and a wide range of shutter speeds. Some cameras have automatic “Through The Lens” (TTL) flash synchronization. These features are very desirable in modern photography, and are currently lacking in single frame 3D Imaging Systems.

The Single Lens Reflex (SLR) camera is an image capturing camera with technologically advanced features which aid in taking high quality pictures. SLR cameras have the added benefit of having standardized interchangeable lens systems.

This permits a 3D Imaging System to be devised which is modular, self-contained and interchangeable with standard Single Lens Reflex camera lenses, and can receive the single image of a subject, split it into dual transposed images in stereo offset and deliver a single frame to an image capturing device, without severe keystone effect and vignetting, while retaining a wide angle of view and a bright image for viewing and metering. This 3D Imaging System needs to combine the advantages and minimize the shortcomings of previously disclosed beam splitter systems to produce 3D images of quality comparable to those produced by a purpose built stereo camera

### SUMMARY OF INVENTION

Accordingly, the present invention is directed to a 3D Imaging System for stereo photographs that substantially obviates one or more of the limitations and disadvantages of prior art 3D Imaging Systems, and unites a previously unavailable combination of desirable features in one device. The advantages and purposes of the invention will be set forth in part in the description which follows, and in part will be obvious from the description, or may be learned by practice of the invention. The advantages and purposes of the invention will be realized and attained by the elements and combinations particularly pointed out in the appended claims. To attain the advantages and in accordance with the purposes of the invention, as embodied and broadly described herein, the present invention is directed to a 3D Imaging System set within a device which can be mounted directly onto the body of a Single Lens Reflex camera. The 3D Imaging System, comprises a mirror beam splitter system having an even number of mirrors; and a lens panel having a pair of lenses; and an aperture panel with a pair of apertures. The beam-splitter turns the single light path from a single subject into dual divergent light paths as viewed from two different angles and projects them through the aperture panel and then the lens pair to form dual images with a 3D offset which can be captured on film, electronic recording media or ground glass in a Single Lens Reflex camera. lt is to be understood that both the foregoing general description and the following detailed description are exemplary and explanatory only and are not restrictive of the invention, as claimed.

### BRIEF DESCRIPTION OF DRAWINGS

The accompanying drawings, which are incorporated in and constitute a part of this specification, illustrate several embodiments of the invention and together with the description, serve to explain the principles of the invention. In the drawings, FIG. 1 is a top sectional view of a 3D Imaging device with staggered mirrors and dual lenses producing parallel light paths.

FIG. 2 is a top sectional view of the 3D Imaging device in FIG. 1 with a pair of wider angle lenses, larger mirrors, and the film plane closer to the lens.

FIG. 3 is an isometric view of a single lens capturing an image and projecting it onto the condenser of a Single Lens Reflex camera. The pentaprism is omitted for clarity.

FIG. 4 is an isometric view of the 3D imaging device in FIG. 1 showing the lens pair, reflector mirror, condenser, eyepiece and light meter cell, illustrating the entry and destination of the light paths captured by the beamsplitter (not shown).

FIG. 5 shows a comparison of ray diagrams of two lens configurations, one with an iris set within the lens and the other with the iris set in front of the lens.

FIG. 6 is an isometric view of the 3D imaging device in the present invention, showing the narrow pitched lens pair, reflector mirror, condenser, eyepiece and light metering cell, illustrating the entry and destination of the light paths captured by the beamsplitter (not shown).

FIG. 7 is a simplified sectional view of the 3D imaging system in FIG. 6, comparing the direction and destination of light paths passing through the same lens placed in three different positions.

FIG. 8 is a top sectional view of the 3D imaging system in FIG. 6, shown mounted on a camera body with an image capturing device.

### DETAILED DESCRIPTION

Reference will now be made in detail to the presently preferred embodiment of the invention, and example of which is illustrated in the accompanying drawings. Wherever possible, the same reference numbers will be used throughout the drawings to refer to the same or like parts.

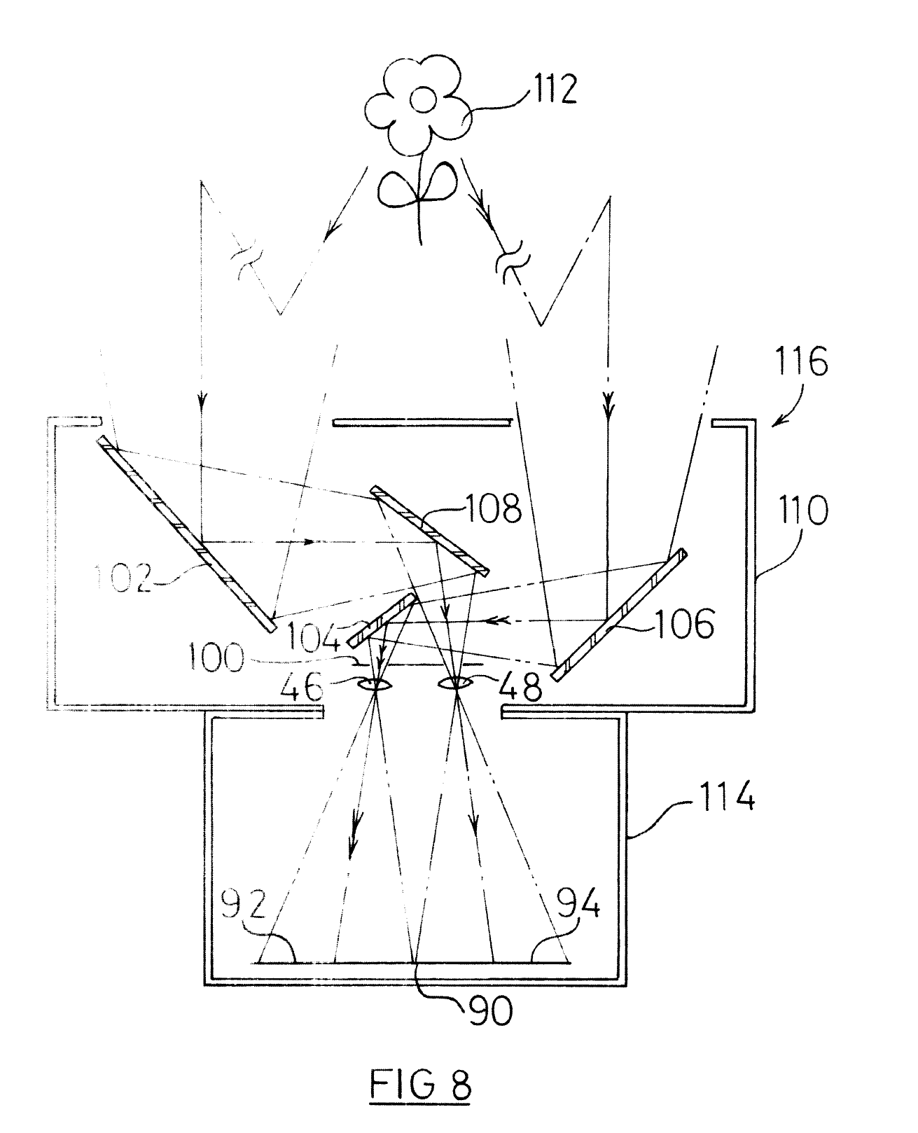

In accordance with the present invention, a 3D imaging system for taking stereo pictures is provided. The 3D imaging system device includes a beam splitter system comprising an even number of mirrors. It also includes a lens panel that has two independent image forming lenses, and an aperture panel with a pair of apertures. In another embodiment the aperture panel may incorporate multiple pairs of different sized apertures. These items are set in a housing 110 according to the configuration described. An exemplary embodiment of the 3D imaging system of the present invention is illustrated in FIG. 8 and is generally designated by reference number 116.

As illustrated in FIG. 8, the 3D imaging system is mounted on an image capturing camera. In the exemplary embodiment the camera body is a Single Lens Reflex (SLR) camera for use with 35 mm film, although the present invention contemplates that the 3D imaging system may be adapted for use with any type of camera body built for an interchangeable lens system. In another embodiment the camera may be one which captures images digitally with a CCD chip or other similar digital device. In yet another alternative the camera body may be one which captures moving images on videotape.

FIG. 1 shows a ray diagram of a good solution in terms of image quality and ease of manufacture. It comprises two image forming lenses items 2 & 4. Mirrors 6 and 8 provide one viewpoint of the subject for lens 2 to form an image 16 on film 14 while mirrors 10 & 12 stacked in front of mirrors 6 and 8 provide another viewpoint of the subject for lens 4 to form a side-by-side image 18 next to image 16 on film 14. It has two inherent drawbacks, particularly if it is used on a single lens reflex camera.

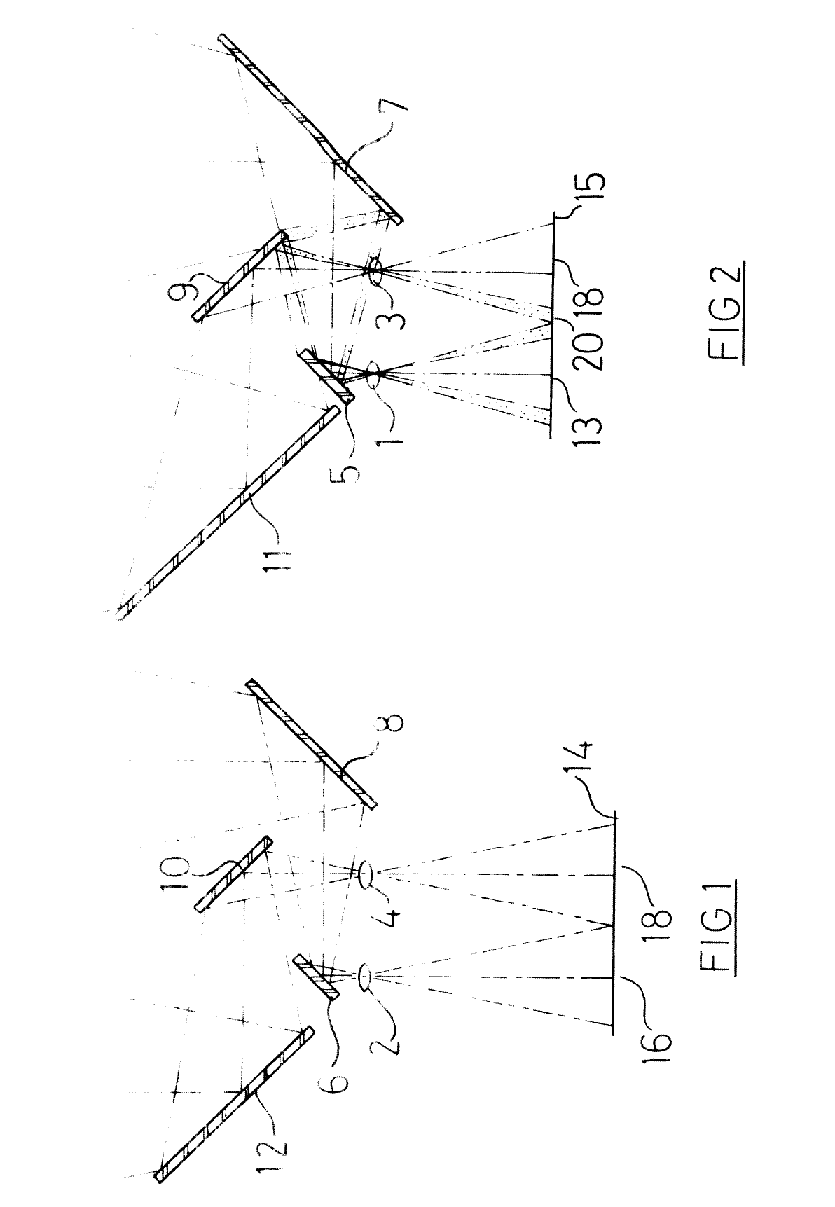

Since the light paths are in the form of a pair of cones which are rather long through the reflector unit and also they are stacked one in front of the other, there is a limit to the angle of view of the camera using this 3D system: a point will soon be reached where the size of the mirror used to capture the rays from one light path is blocking the rays from the other ray light path, thus blocking off part of the image which should be recorded on the film, see FIG. 2. FIG. 2 shows the same unit as FIG. 1 but with a pair of wider angle lenses 1 & 3. To accommodate this wider angle, mirrors 5, 7, 9 and 11 have to be enlarged. In doing so part of mirror 5 now intrudes into the field of view of lens 3 of the image as reflected by mirror 11. As a result vignetting of part of images 16 and 18 is shown at 20. The field of view of mirror 7 is determined by light rays striking it at either end. At the end of mirror 7 which is close to lens 3, the incident light rays are blocked by part of mirror 9. At the end of mirror 7 which is away from lens 3, the reflected light rays are blocked by mirror 9 and prevented from reaching mirror 5.

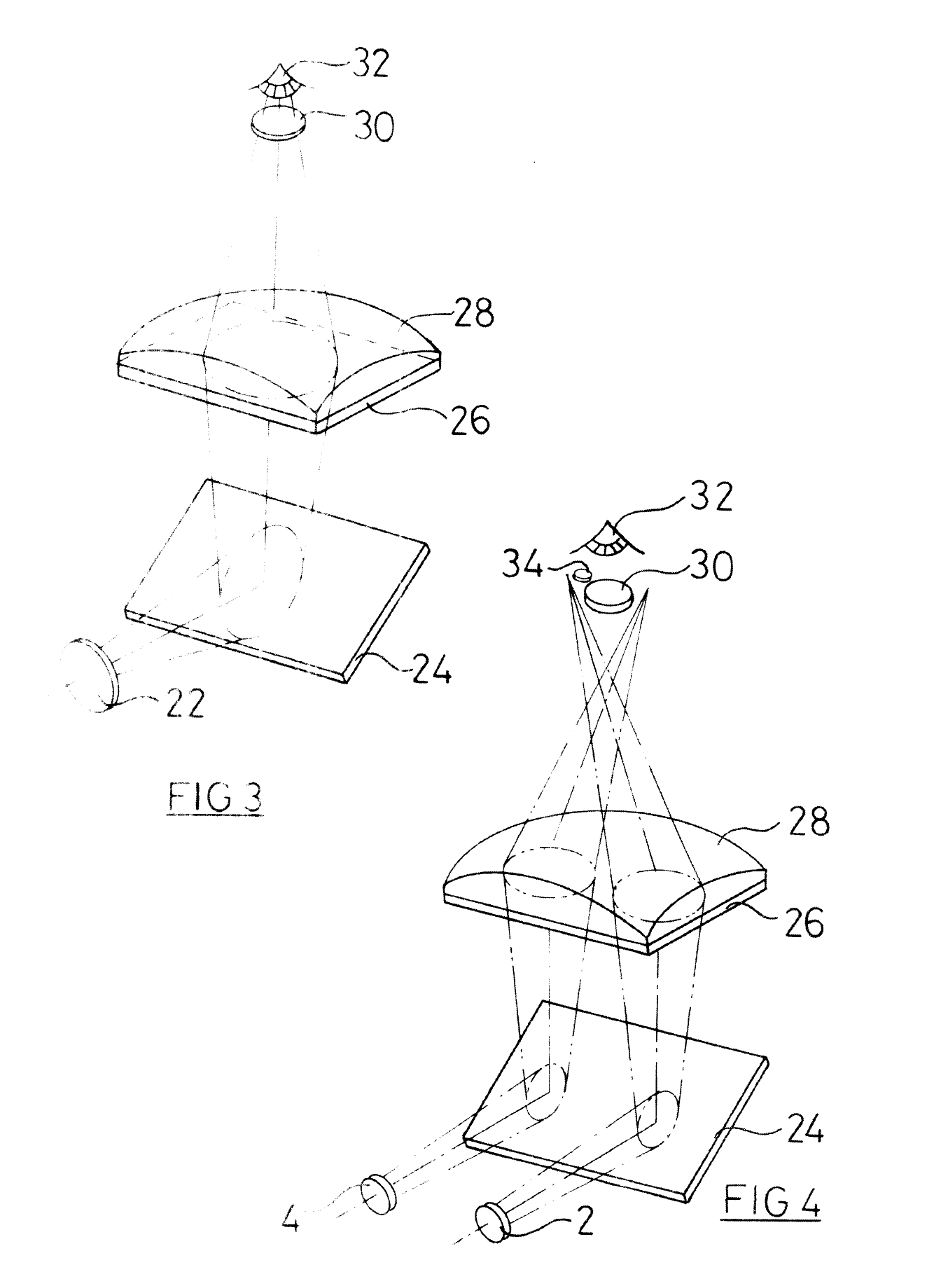

If this system is used in an SLR camera, the view finder system should be able to show the pair of side by side images in the viewing screen through the eye-piece. This becomes mandatory if the camera exposure control relies on light sensors measuring the brightness of the screen images. In practice, to improve the brightness of the viewed images, all modern single lens reflex cameras are fitted with a condenser lens system next to the ground glass. This condenser system assumes the image forming lens to be in the centre of the film and therefore also in the centre of the viewing screen, see FIG. 3. FIG. 3 shows an isometric view of an SLR camera viewfinder where camera lens 22 forms an image on ground glass 26 after being deflected by mirror 24. The condenser lens 28 receives the ground glass image and concentrates the illumination through eyepiece 30 to reach eye 32. For clarity, the pentaprism responsible for providing eyelevel viewing is omitted in FIG. 3.

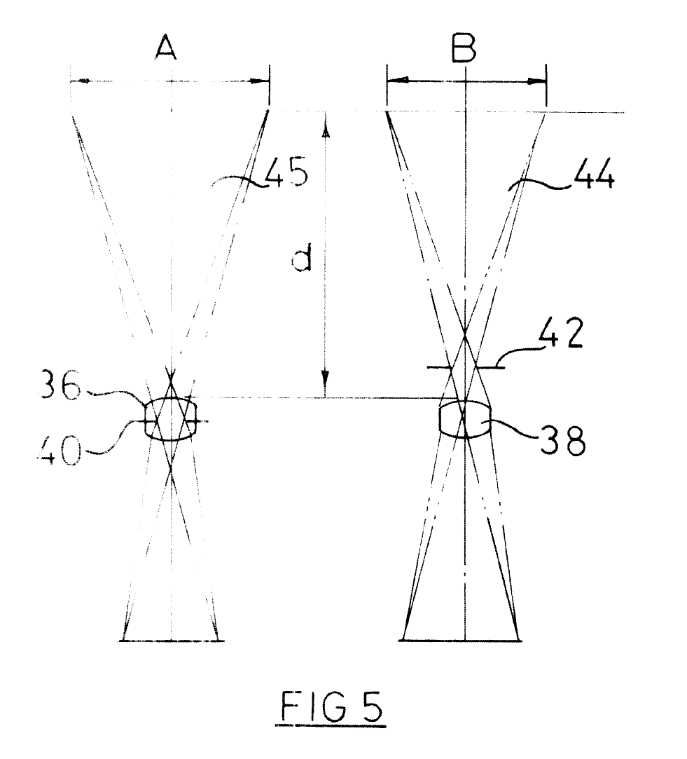

Unfortunately, this 3D system uses a pair of image forming lenses that are at about the same pitch as the pair of 3D images they form on the film. The centre line of these lenses no longer lines up with the ground glass condenser lens system in the viewfinder. The more efficient the condenser system the less light it will direct to the eye-piece viewing area from these off-axis lenses. The result is a pair of very dark images. Since the exposure control of a modern single lens reflex camera collects exposure information from the brightness of the image near the eye-piece position, the light meter is also fooled into giving extremely long exposure since the meter cells no longer receive the correct image brightness information compared with a conventional lens which corresponds to what the film is expected to receive, see FIG. 4.

FIG. 4 shows an isometric view of an SLR camera fitted with a 3D attachment similar to the one shown in FIG. 1. Now the image produced by lens 2 is formed directly on but to one side of ground glass 26, and is acted on by the off-center part of condenser lens 28.

The condensed image is now directed to a point outside of the viewfinder eyepiece 30 and the exposure meter cell 34, which is near the eyepiece. The result is a dark image when viewed at the eyepiece 30 position. Lens 4 is symmetrical to lens 2 and the corresponding result is the same.

As illustrated in FIG. 5, a pair of image forming lenses can be designed with the iris in the front. By doing this the image ray cones through the reflector system can be minimized. There are two benefits to this. Firstly, for a given size of reflector, the angle of view is increased. Secondly, the overall size of the reflector housing is reduced because the image ray cones are reduced.

A comparison is shown in FIG. 5. There are two ray diagrams of two lenses 36 & 38 with identical focal lengths. Aimed at the same object, the image size will be the same. However for a given distance from the front of the lens d, image cone 44 of the lens 38 with the iris in the front will be smaller than image cone 45 of lens 36 with the iris set within the lens. That is, B is less than A.

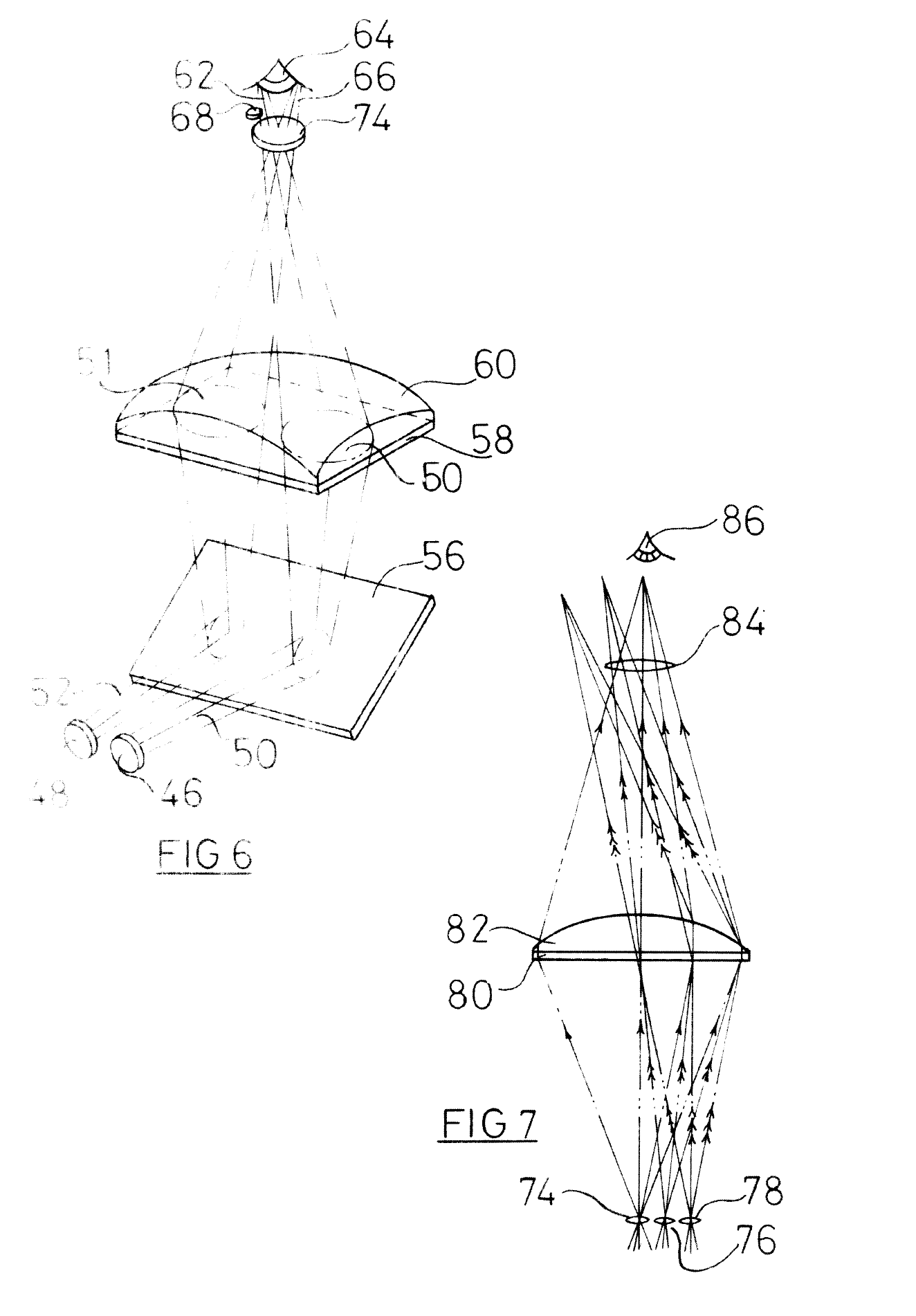

As illustrated in FIG. 6, the two 3D image forming lenses can be moved closer together and the reflectors angle designed to allow the images at the film plane to be maintained at the correct pitch. There are two benefits in doing this. Firstly, the length of the image cones through the reflector system of a stacked crossover design system is further reduced, so an even wider angle of view and smaller reflector size becomes possible without increasing the size of the mirrors. Secondly, applied to the SLR camera, the ray paths from the pair of lenses are less off-axis and closer to design requirements of the condenser lens of the viewing screen meant for conventional on-axis lenses.

The result is a brighter viewed image and more accurate exposure control. This exposure control is good enough for colour negative film and can be fine turned with exposure compensation if desired.

Since the pair of images in the viewfinder are condensed to either side, but still within the area of the viewfinder eyepiece, see FIG. 6, the camera user will see an even brighter image if the eye is moved slightly to one side of the viewfinder eyepiece and look obliquely through the viewfinder. In this case the other image will appear correspondingly darker.

With reference to FIG. 6 showing an isometric view of the improved 3D imaging system, the two image forming lenses, 46 and 48, are now close together (closer than the image pitch at the plane of focus or film plane). For clarity the pentaprism responsible for providing eyelevel viewing is omitted Consider lens 46, the ray which eventually forms the center of image item 50 is now diverging. After it is reflected by mirror 56, it continues to diverge. If rays were radiating from a single lens mounted along the center line of the film, the ray which forms an image at 70 will strike the ground glass at a slightly greater angle and match the condenser lens optics properly.

FIG. 7 is a simplified sectional view of FIG. 6, It illustrates the way the light paths are bent by the lens and condenser. For clarity the Single Lens Reflex camera mirror has been omitted. The set of rays passing through the prime (normal) lens 74 is focused perfectly by the condenser on eyepiece 84. The rays passing through the lens on the far right are refracted through a wide angle by the condenser and end up being focused at a point far left of eyepiece 84, outside the field of view of viewing eye 86. This results in a very dark viewing image.

The rays passing through the lens 76 shifted slightly to the right (as proposed by the improved 3D imaging system) are also refracted by the condenser to the left of the eyepiece 84 but end up being focused at a point within the field of view of the eyepiece 84 albeit to the left of the center line. This provides a good viewing image, which is also bright enough for light metering.

This invention is now described by way of an example, although this is a design for a SLR camera, it can also be applied to a simple camera using a separate view finder.

FIG. 8 shows a sectional view of the improved 3D imaging system in a simplified housing 110, mounted on a simplified representation of camera body 114. The camera body contains image recording film 90 onto which two side by side 3D images 92 and 94 are projected by the pair of lenses 46 and 48. The pitch of the images 92 and 94 is wider than the pitch of lenses 46 and 48. In front of the pair of lenses are a pair of adjustable irises 100 which allow rays from the object reflected through the beamsplitter system comprising mirrors 102, 104, 106 and 108 to pass through. The angles of the mirrors 102, 104, 106 and 108 are adjusted to keep the image pitch the same as before the improvement is introduced.

Consider the light radiating from object towards mirror 8. This is reflected towards mirror 9 and then through the iris and image forming lens 2 to be focused onto the film 1 forming image 4).

Consider the light radiating from the subject 112 towards mirror 102. It is reflected towards mirror 104 and then through the iris and image forming lens 46 to be focused onto the film forming an image 92.

It will be apparent to those skilled in the art that various modifications and variations can be made in the construction of this 3D imaging system without departing from the scope or spirit of the invention. Other embodiments of the invention will be apparent to those skilled in the art from consideration of the specification and practice of the invention disclosed herein. It is intended that the specification and examples be considered as exemplary only.

1. A 3D Imaging System Using Reflectors, comprising a mirror beam splitter system having an even number of mirrors and a lens panel having a pair of lenses and an aperture panel with a pair of apertures;
where the beam splitter turns the single light path from a single subject into dual divergent light paths as viewed from two different angles and projects them through the aperture panel and then the lens pair to form dual images with a 3D offset which can be captured on film, electronic recording media or ground glass in a Single Lens Reflex (SLR) camera.

2. The beam splitter in claim 1 having an even number of mirrors in a staggered formation in which one group of mirrors is set in front of the other to allow the light paths to crossover to form dual transposed images.

3. The lens pair in claim 1 positioned so that the light paths passing through them are sufficiently wide apart to accommodate the two inner mirrors while close enough together so that the intensity and incident angle of the combined light paths has an effect on the viewfinder and light meter measurable to within two aperture stops to that of a single light path.
